(19) United States
(12) Patent Application Publication
(10) Pub. No.: US 2007/0027849 A1
(43) Pub. Date: Feb. 1, 2007

(54) Integrating query-related operators in a programming language

(75) Inventors: Henricus Johannes Maria Meijer, Mercer Island, WA (US); Anders Hejlsberg, Seattle, WA (US); Matthew J. Warren, Redmond, WA (US); Luca Bolognese, Redmond, WA (US); Peter A. Hallam, Seattle, WA (US); Gary S. Katzenberger, Woodinville, WA (US); Dinesh C. Kulkarni, Sammamish, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/193,787

(22) Filed: Jul. 29, 2005

(51) Int. Cl. G06F 17/30

(52) U.S. Cl. 707/3

(57) ABSTRACT

A general-purpose programming language having language extensions for strongly typed, compile-time checked query and set operations that can be applied to arbitrary data structures, be they object-relational (O-R) mappings or just regular objects. As is appropriate for a general purpose programming language, the extensions do not mandate a particular object-relational layer; rather, they are introduced as abstractions that can be implemented in multiple environments. Accordingly, there is provided a system that facilitates data querying in accordance with an innovative aspect. The system include a program component that provides embedded query and set operations in a programming language, and an application component that facilitates application of the query and set operations over a data structure of data. The data can be any kind of data such as that found in a database, a document (e.g., XML), and data sources in a programming language (e.g., C#), for example.

### BACKGROUND

The advent of global communications networks (e.g., the Internet) now makes accessible an enormous amount of data. People access and query unstructured and structured data every day. Unstructured data is used for creating, storing and retrieving reports, e-mails, spreadsheets and other types of documents, and consists of any data stored in an unstructured format at an atomic level. In other words, in the unstructured content, there is no conceptual definition and no data type definition—in textual documents, a word is simply a word. Current technologies used for content searches on unstructured data require tagging entities such as names or applying keywords and metatags. Therefore, human intervention is required to help make the unstructured data machine readable. Structured data is any data that has an enforced composition to the atomic data types. Structured data is managed by technology that allows for querying and reporting against predetermined data types and understood relationships.

Programming languages continue to evolve to facilitate specification by programmers as well as efficient execution. In the early days of computer languages, low-level machine code was prevalent. With machine code, a computer program or instructions comprising a computer program were written with machine languages or assembly languages and executed by the hardware (e.g., microprocessor). These languages provided an efficient means to control computing hardware, but were very difficult for programmers to comprehend and develop sophisticated logic.

Subsequently, languages were introduced that provided various layers of abstraction. Accordingly, programmers could write programs at a higher level with a higher-level source language, which could then be converted via a compiler or interpreter to the lower level machine language understood by the hardware. Further advances in programming have provided additional layers of abstraction to allow more advanced programming logic to be specified much quicker then ever before. However, these advances do not come without a processing cost.

The state of database integration in mainstream programming languages leaves a lot to be desired. Many specialized database programming languages exist, such as xBase, T/SQL, and PL/SQL, but these languages have weak and poorly extensible type systems, little or no support for object-oriented programming, and require dedicated run-time environments. Similarly, there is no shortage of general purpose programming languages, such as C#, VB.NET, C++, and Java, but data access in these languages typically takes place through cumbersome APIs that lack strong typing and compile-time verification.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The disclosed innovation includes language extensions for strongly typed, compile-time checked query and set operations that can be applied to arbitrary data structures, be they object-relational (O-R) mappings, XML, or just regular objects. As is appropriate for a general purpose programming language, the extensions do not mandate a particular object-relational layer; rather, they are introduced as abstractions that can be implemented in multiple environments. Accordingly, there is provided a system that facilitates data querying in accordance with an innovative aspect. The system include a program component that provides embedded query and set operations in a programming language, and an application component that facilitates application of the query and set operations over a data structure of data. The data can be any kind of data such as that found in a database, a document (e.g., XML), and data sources in a programming language (e.g., C#), for example.

In another aspect, operators are provided that facilitate restriction, projection, testing, aggregation, ordering, grouping, sets, catenation, casting, singleton processing, converting, and partitioning.

In another aspect thereof, deferred execution is provided. When an expression with one or more sequence operators is received, and expression execution is initiated, overall execution is delayed as one or more operators execute to create one or more intermediary sequence objects. The one or more intermediary objects are initialized, and the query results are computed on-the-fly as sequence objects are enumerated.

In another innovative aspect, sequence aliasing is provided to explicitly name a current element of a sequence.

In yet another aspect, a query can be remoted to a data source whereat the query is executed and relevant results returned.

In still another aspect of the subject innovation, operations of create, update and delete operations arte provided as integral to the language.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a system that facilitates data querying in accordance with an innovative aspect.

FIG. 2 illustrates a methodology of providing query and set operations in a general-purpose programming language.

FIG. 3 illustrates a table of operators that can be employed to operate over data in accordance with the disclosed embedded query and set of operations.

FIG. 4 illustrates a block diagram representative of an operator that facilitates mapping and/or projection in accordance with another aspect of the innovation.

FIG. 5 illustrates a methodology of composing operators in accordance with an aspect.

FIG. 6 illustrates a block diagram representative of an operator that provides data aggregation functionality in accordance with the disclosed innovation.

FIG. 7 illustrates a block diagram representative of an operator that provides test conditions for data in accordance with an aspect.

FIG. 8 illustrates a block diagram representative of an operator that provides element extraction in accordance with an aspect.

FIG. 9 illustrates a block diagram representative of an operator that facilitates sequence ordering in accordance with an aspect.

FIG. 10 illustrates a block diagram representative of an operator that facilitates structuring a result of a sequence operation according to a grouping in accordance with an aspect.

FIG. 11 illustrates a methodology of filtering a sequence using an embedded operator according to an aspect.

FIG. 12 illustrates a block diagram representative of an operator that provides set theory operators in accordance with an aspect.

FIG. 13 illustrates a block diagram representative of an operator that provides an entity for explicitly naming a current element of a sequence in accordance with an aspect.

FIG. 14 illustrates a methodology providing deferred execution in accordance with an innovative aspect.

FIG. 15 illustrates a methodology of remoting a query to a remote database in accordance with an aspect.

FIG. 16 illustrates a flow diagram of a methodology compiler processing in response to remoting a query according to an aspect.

FIG. 17 illustrates a block diagram representative of an operator that provides fundamental operations in accordance with an aspect.

FIG. 18 illustrates a flow diagram of a methodology of populating a collection when executing a query.

FIG. 19 illustrates exemplary code to depict deferred query execution.

FIG. 20 illustrates a block diagram of a computer operable to execute the disclosed programming language architecture.

FIG. 21 illustrates a schematic block diagram of an exemplary computing environment that facilitates execution of embedded operators of a programming language in accordance with another aspect.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

The disclosed innovation includes language extensions for strongly typed, compile-time checked query and set operations that can be applied to arbitrary data structures, be they object-relational (O-R) mappings, XML, or just regular objects. As is appropriate for a general purpose programming language, the extensions do not mandate a particular object-relational layer; rather, they are introduced as abstractions that can be implemented in multiple environments, including, for example, ObjectSpaces (a technology that facilitates building services supporting object representations of data in relational databases), MBF (Microsoft Business Framework), and WinFS. Following is an example of code that employs one such operator, a where operator:
sequence<Customer>locals=customers.where(ZipCode==98112);

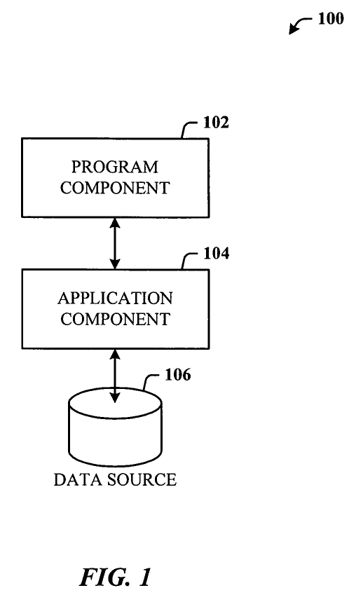

Referring initially to the drawings, FIG. 1 illustrates a system 100 that facilitates data querying in accordance with an innovative aspect. The system 100 include a program component 102 that provides embedded query and set operations in a programming language, and an application component 104 that facilitates application of the query and set operations over a data structure of data 106. The data can be any kind of data such as that found in a database, a document (e.g., XML), and data sources in a programming language (e.g., C#), for example.

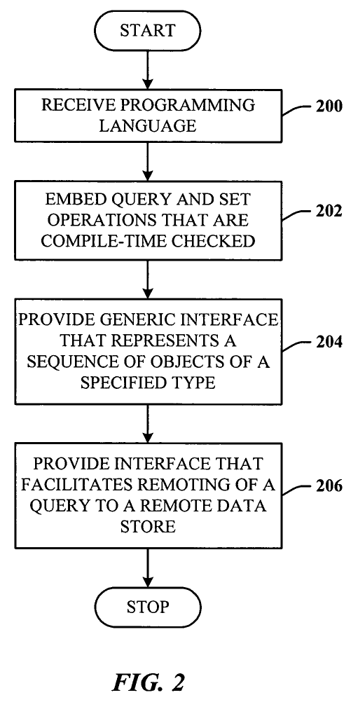

FIG. 2 illustrates a methodology of providing query and set operations in a general-purpose programming language. While, for purposes of simplicity of explanation, the one or more methodologies shown herein, e.g., in the form of a flow chart or flow diagram, are shown and described as a series of acts, it is to be understood and appreciated that the subject innovation is not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 200, a programming language is received. At 202, query and/or set operations are embedded therein and that can be compile-time checked. At 204, a generic code interface is provided that represents a sequence of objects of a specified type. At 206, another code interface is provided that facilitates remoting of a query to a remote data store or source.

The introduction of generic interfaces (“generics”) in a programming language (e.g., C# Version 2.0) puts in place a foundation for providing better data access in the language. With generics it is possible to preserve strong typing in many scenarios where the all-purpose object type would have otherwise been used.

The disclosed query and set operations revolve around an IEnumerable<T>generic interface. IEnumerable<T>represents a sequence of objects of a specified type. The IEnumerable<T>interface supports an operation-creation of a forward-only IEnumerator<T>that enumerates the sequence. Any object that implements IEnumerable<T>can be enumerated using, for example, C#'s foreach statement.

Because IEnumerable<T>requires very little of the implementing type, it is implemented by a large number of types in a .NET Framework, for example, including all array types, List<T> and Dictionary<K, V> collection classes and, ObjectSet<T> and ObjectReader<T> classes in ObjectSpaces.

Attributes of IEnumerable<T> include the following: strongly typed—the element type of the sequence is specified as a generic type parameter; it can equally well represent arrays, collections, database tables, and database queries (the latter two through O-R mappings); it allows multiple enumerations of the represented sequence —an IEnumerable<T> is not itself an enumerator, but rather an enumerator factory; it allows deferred execution of any work required to produce the represented sequence—for example, if an IEnumerable<T> represents a database query, the query does not need to be executed until the IEnumerable<T> is used in a foreach statement; and, it is ideally suited for functional composition—an implementation of IEnumerable<T> can be built to consume another IEnumerable<T> and perform transformations such as filtering and projection.

In this description, the term sequence type is used for any type constructed from IEnumerable<T>. For improved readability, a sequence type can be written as
sequence<T>
   where T is the element type of the sequence. For example, sequence<Customer> is a sequence of Customer objects and sequence<string> is a sequence of strings.

When sequence types are used to represent collections and database tables, it is beneficial to provide sequence operators for the operations that are commonly performed on sequences. Examples of such operations include filtering, projection, and aggregation. The disclosed sequence operators can be introduced through a series of examples that use the classes below. The classes can be an O-R mapping of a database, but they could equally well just be a set of regular classes.

```
public class Customer
{
    public string CustomerID;
    public string Name;
    public string Address;
    public string City;
    public string State;
    public int ZipCode;
    public string Phone;
    public Collection<Order> Orders { get; }
}
public class Order
{
    public int OrderID;
    public string CustomerID;
    public DateTime OrderDate;
    public Customer Customer { get; }
    public Collection<LineItem> LineItems { get; }
}
public class LineItem
{
    public int OrderID;
    public int LineNo;
    public int ProductID;
    public decimal UnitPrice;
    public int Quantity;
    public decimal Discount;
    public Order Order { get; }
    public Product Product { get; }
}
public class Product
{
    public int ProductID;
    public string Description;
    public string Category;
    public decimal UnitPrice;
    public int UnitsInStock;
    public Collection<LineItem> LineItems { get; }
}
```

In the classes, one-to-one and one-to-many relations can be captured as properties of the appropriate class and collection types. For example, an Order has a Customer property of type Customer (a one-to-one relation) and a LineItems property of type Collection<LineItem> (a one-to-many relation).

The generic Collection<T>type used in the classes can be any sequence type, e.g., any type that implements IEnumerable<T>. It can implement a materialized collection of objects or it could be a proxy for a lazily executed query.

The examples that follow assume the existence of two collections:

List<Customer> customers = GetCustomerList( );
List<Product> products = GetProductList( );

Because List<T> implements IEnumerable<T>, List<T> is a sequence type and sequence operators can be applied to instances of List<T>.

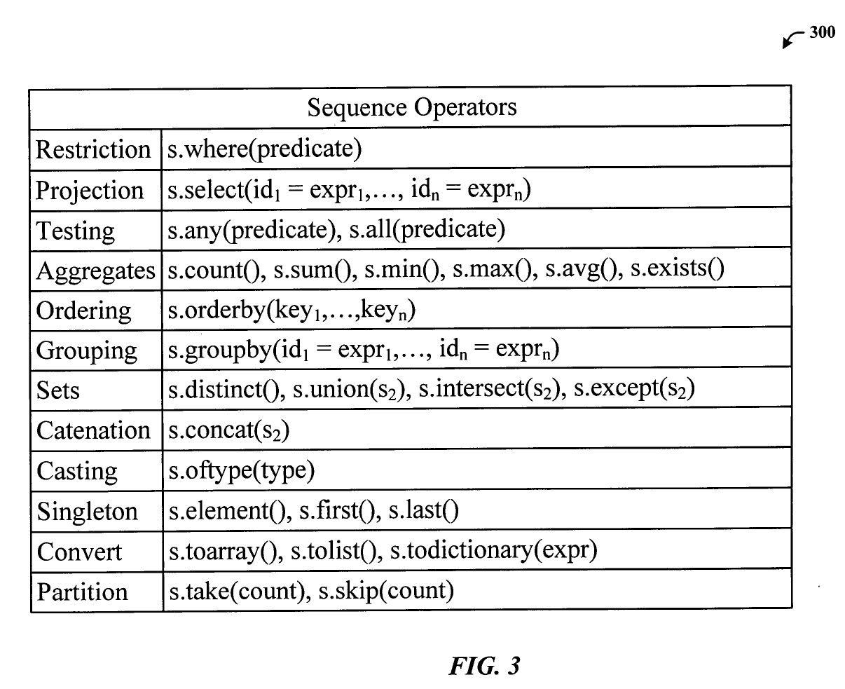

FIG. 3 illustrates a table 300 of operators that can be employed to operate over data in accordance with the disclosed embedded query and set of operations. Additionally, the following table illustrates the operators, and forms the basis infra for the introduction of some or all of the sequence operators and associated details of their usage.

| | |
|---|---|
| Restriction | s.where(predicate) |
| Projection | s.select(id₁ = expr₁, ..., idₙ = exprₙ) |
| Testing | s.any(predicate), s.all(predicate) |
| Aggregates | s.count( ), s.sum( ), s.min( ), s.max( ), s.avg( ), |
| | s.exists( ) |
| Ordering | s.orderby(key₁,...,keyₙ) |
| Grouping | s.groupby(id₁ = expr₁,...,idₙ = exprₙ) |
| Sets | s.distinct( ), s.union(s₂), s.intersect(s₂), |
| | s.except(s₂) |
| Catenation | s.concat(s₂) |
| Casting | s.oftype(type) |
| Singleton | s.element( ), s.first( ), s.last( ) |
| Convert | s.toarray( ), s.tolist( ), s.todictionary(expr) |
| Partition | s.take(count), s.skip(count) |

Filtering: The where operator. To filter a sequence, a where operator is provided. The following where operation returns a sequence of those customers that have a zip code of 98112.
sequence<Customer>locals=customers.where(ZipCode==98112);

The predicate expression can be written as a regular C# Boolean expression and the members of the current element are automatically in scope. When necessary, the entire current element can be referenced using the identifier it, as illustrated below:
sequence<Customer>bigCustomers=customers.where(IsBigCustomer(it));

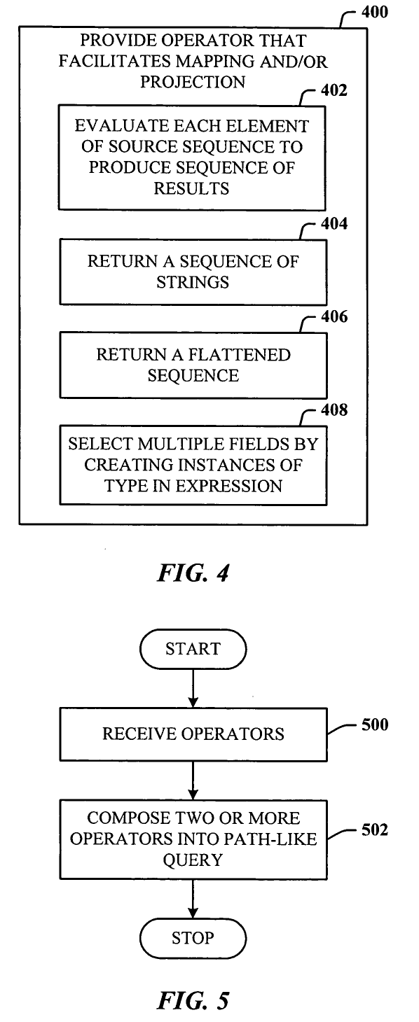

FIG. 4 illustrates a block diagram representative of an operator 400 that facilitates mapping and/or projection in accordance with another aspect of the innovation. At 402, the operator 400 provides the capability of evaluating each element of a source sequence to produce a sequence of results. Additionally, at 404, the operator facilitates returning a sequence of strings. At 406, the operator 400 allows for returning a flattened sequence. Lastly, the operator allows for selecting multiple fields by creating instances of a type in an expression.

A select operator is provided for mapping and projection. The following select operation returns a sequence of the Name fields of each customer:
sequence<string>names=customers.select(Name);

The select operator evaluates the given expression for each element in the source sequence, producing a sequence of the results. Similar to the where operator, the members of the current element are automatically in scope and the entire current element can be referenced using the identifier it.

A select expression can do more than just select a field. For example, the following operation returns a sequence of strings containing customer names and phone numbers.
sequence<string>nameNumbers=customers.select(Name+″,″+Phone);

If a select expression selects a sequence, the result of the select operation is a “flattened” sequence, not a sequence of sequences. The following returns a sequence of the orders of the customers in the customers collection:
sequence<Order>orders=customers.select(Orders);

Because of flattening, the result is a sequence<Order>, not a sequence<sequence<Order>>.

Multiple fields can be selected by creating instances of an appropriate type in the select expression. For example, to select the Name and Phone fields from a sequence of customers, a Contact class can be declared:

```
public class Contact
{
    public string Name;
    public string Phone;
    public Contact(string name, string phone) {
      Name = name;
      Phone = phone;
    }
}
```

This class can then be used in a select operation:
sequence<Contact>contacts=customers.select(new Contact(Name, Phone));

Sequence operators use a method-like syntax that is ideally suited for composition into path-like queries. The following syntax combines a where and select operation to produce a sequence of the names of those customers that reside in California:

sequence<string> californians =
customers.where(State == “CA”).select(Name);

The following syntax produces a sequence of those orders that were placed by customers in California in the year 2003:

```
sequence<Order> lastYearCaOrders =
    customers.where(State == “CA”).
    select(Orders).where(OrderDate.Year == 2003);
```

Accordingly, FIG. 5 illustrates a methodology of composing operators in accordance with an aspect. At 500, a plurality of operators is received. At 502, two or more of the operators can be composed into a path-like query.

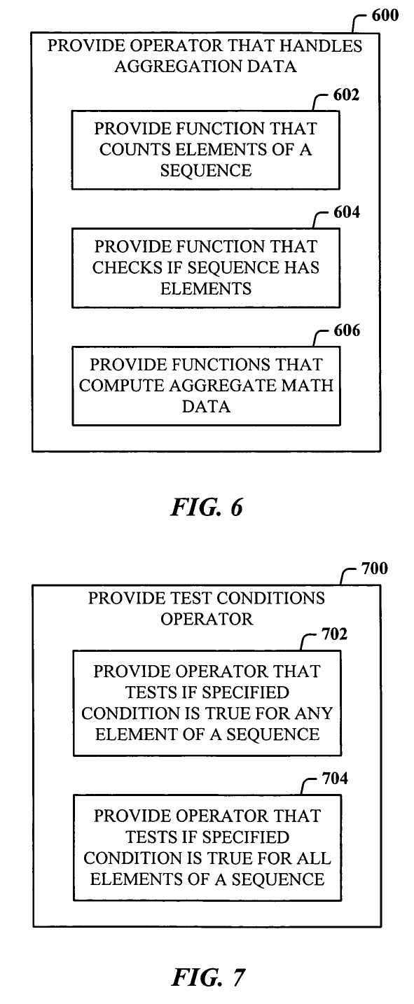

Referring now to FIG. 6, there is illustrated a block diagram representative of an operator 600 that provides data aggregation functionality in accordance with the disclosed innovation. At 602, a function is provided that counts elements of a sequence. At 604, a function is provided that checks if a sequence has elements. At 606, functions are provided that compute math operations over the data.

Accordingly, a count function is provided that computes the number of elements in a sequence. For example, the following counts the number of customers in the 98112 zip code:
int localsCount=count(customers.where(ZipCode==98112));

An exists function checks whether a sequence contains any elements. The following returns a sequence of those customers that have one or more orders:
sequence<Customer>custsWithOrders=customers.where(exists(Orders));

The min, max, sum, and avg functions compute the minimum, maximum, sum, and average of sequence. For example, given a variable order of type Order, the following uses the sum function to compute the order total:

decimal orderTotal =
sum(order.LineItems.select(UnitPrice * Quantity − Discount));

FIG. 7 illustrates a block diagram representative of an operator 700 that provides test conditions for data in accordance with an aspect. At 702, an operator is provided that tests a specified condition for any element of a sequence. Herein, an any operator returns true if the specified condition is true for any element in a sequence. The following returns a sequence of those customers that placed orders on today's date:

sequence<Customer> orderedToday =
customers.where(Orders.any(OrderDate == DateTime.Today));

At 704, an operator is provided that tests a specified condition for all elements of a sequence. As disclosed herein, an all operator returns true if the specified condition is true for all elements in a sequence. The following returns a sequence of those customers with orders that have always included wine:

```
sequence<Customer> orderedWineAlways =
    customers.where(exists(Orders) &&
      Orders.all(LineItems.any(Product.Category == “Wine”)));
```

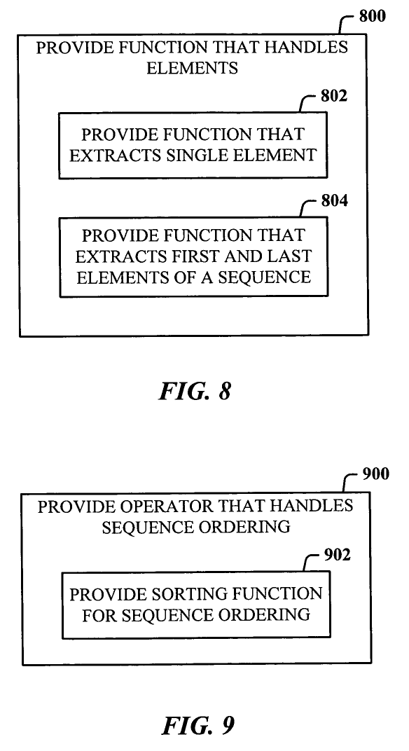

FIG. 8 illustrates a block diagram representative of an operator 800 that provides element extraction in accordance with an aspect. At 802, an element extraction function is provided that extracts the single element of a one-element sequence. For example, the following returns the customer with the CustomerID given by id:
Customer c=element(customers.where(CustomerID==id));

The element function throws an exception if the given sequence is empty and may throw an exception if the given sequence contains more that one element.

At 804, a function is provided that extracts a first and a last element of a sequence. As provided herein, first and last functions extract the first or last element of a sequence. Unlike element, first and last do not throw an exception if the sequence contains more than one element.

FIG. 9 illustrates a block diagram representative of an operator 900 that facilitates sequence ordering in accordance with an aspect. The operator 900 includes a sorting function 902 for sequence ordering. Accordingly, an orderby operator is provided to control the ordering of a sequence. For example, the following produces a sequence of customers ordered by name:
sequence<Customer>customersByName=customers.orderby(Name);

Multiple sort keys may be specified, separated by commas. A sort key may optionally be prefixed with ascending or descending. For example, the following produces a sequence of products ordered by category and, within each category, descending unit price:

sequence<Product> productsByCategoryAndPrice =
products.orderby(Category, descending UnitPrice);

Each sort key is an expression of a type that implements IComparable or
IComparable<T>.

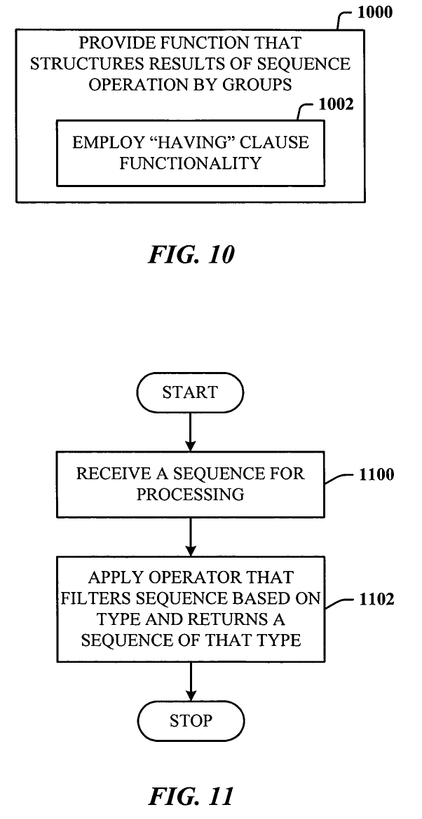

FIG. 10 illustrates a block diagram representative of an operator 1000 that facilitates structuring a result of a sequence operation according to a grouping in accordance with an aspect. At 1002, a having clause can also be employed. The groupby operator can be used to structure the result of a sequence operation according to certain groupings. It takes as parameters the fields to group on and returns an anonymous type that represents the grouped result. Following is exemplary syntax whereby a simple groupby returns the number of items in stock for each category:

```
var categories = products.
    groupby(Category).
    select(Category, InStock = Group.sum(ItemsInStock));
```

It is possible to perform an operation similar in semantics to the having clause in the SQL (structure query language) language, by adding a where clause after the groupby operator. The following code returns just the Categories where the number of items in stock is less than 600:

var categories = products.
groupby(Category).where(Group.sum(ItemsInStock) <
600).select(Category);

FIG. 11 illustrates a methodology of filtering a sequence using an embedded operator according to an aspect. At 1100, a sequence is received for processing. At 1102, an operator is applied that filters the sequence based on a type, and returns a sequence of that type. Accordingly, an of type operator is provided that filters a sequence based on type and returns a sequence of that type. The following code returns just the customers from a heterogeneous sequence:
sequence<Manager>custs=custs.oftype(Manager);

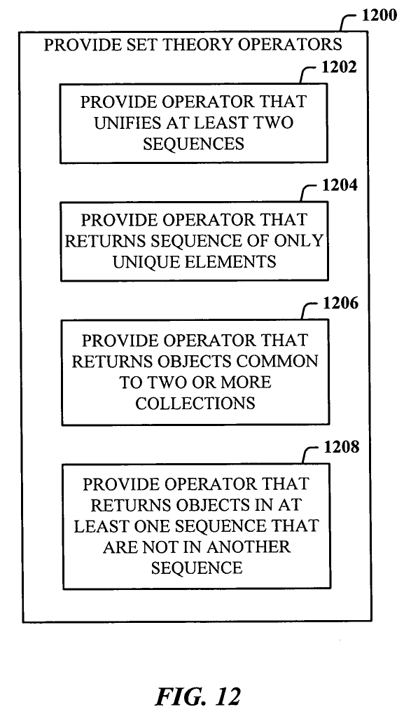

FIG. 12 illustrates a block diagram representative of an operator 1200 that provides set theory operators in accordance with an aspect. At 1202, an operator is provided that unifies at least two sequences. A union operator is provided that unifies two sequences discarding the duplicated objects. For example the following code returns all the zip codes for customers in the state of Washington and all the zip codes for managers who live in Portland:

```
sequence<int> mgrZipCodes =
      managers.where(City==”Portland”).select(ZipCode);
sequence<int> custsZipCodes =
      custs.where(State==”WA”).select(ZipCode);
sequence<int> zipCodes = custsZipCodes.union(mgrZipCodes);
```

At 1204, an operator is provided that returns a sequence of only unique elements. A distinct operator is used to return a sequence that contains just unique elements. The compiler calls Equals on each object in the sequence to compare it with the other objects in the sequence. For example, the following code returns just the unique zip codes where customers live:
sequence<int>zipCodes=customers.select(ZipCode).distinct();

At 1206, an operator is provided that returns objects common to two or more collections. At 1208, an operator is provided that returns objects in at least one sequence that are not in another sequence. An intersect operator returns all the objects that are present in both collections, and an except operator is the complementary operation and returns all the objects that are present in one sequence, but not in the other. The following code returns all the cities where both employees and customers live:

sequence<City> empCities = employers.select(City);
sequence<City> custCities = custs.select(City);
sequence<City> cities = empCities.intersect(custCities);

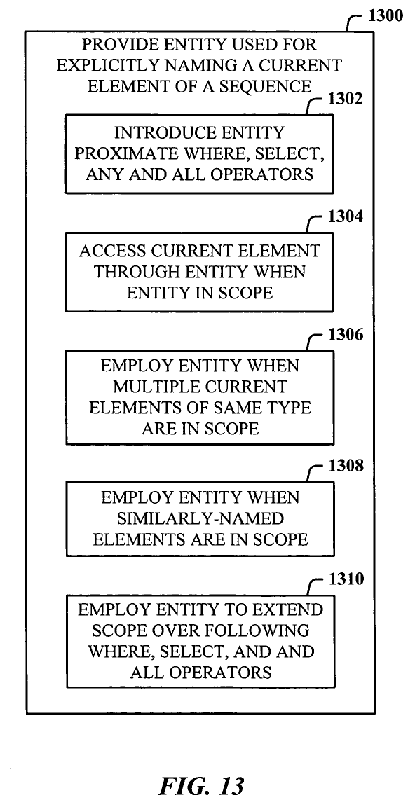

FIG. 13 illustrates a block diagram representative of an operator 1300 that provides an entity for explicitly naming a current element of a sequence in accordance with an aspect. A sequence alias is used to explicitly name the current element of a sequence. For example:
sequence<Customer>locals=customers{c}.where(c.ZipCode==98112);

The {c} sequence alias above associates the identifier c with the current element of customers. At 1302, a sequence alias can be introduced immediately before a where, select, any, or all operator, and is in scope in the expressions of each following where, select, any, or all operator. At 1304, when a sequence alias is in scope, the members of that current element can be accessed through the alias. In another implementation, the members of that current element can only be accessed through the alias. Thus, until employing the sequence alias, current member elements are implicit.

At 1306, sequence aliases can be employed when multiple current elements of the same type are within scope substantially simultaneously. At 1308, sequence aliases can be employed when similarly named members are in scope. For example, the following produces a sequence of the most expensive products in each category:

```
sequence<Product> mostExpensive =
    products{p}.where(p.UnitPrice ==
      max(products.where(Category == p.Category).select(UnitPrice)));
```

In the innermost where expression, two Product elements are in scope and a sequence alias is needed to used the outer element.

At 1310, a sequence alias extends the scope of a current element over each following where, select, any, and all operator. In the following example, the alias c extends over both of the select operators, allowing the second select operator to “reach back” and access the current customer:

```
sequence<OrderInfo> orderInfos =
      customers{c}.
      select(c.Orders){o}.
      select(new OrderInfo(o.OrderId, o.OrderDate, c.Name));
```

A feature of the disclosed sequence operators is that they can provide deferred execution. A sequence object produced by a sequence operator is essentially a proxy for a deferred query. In the following example,
sequence<Customer>locals=customers.where(ZipCode==98112);
   the where operator does not immediately execute the query. Instead, the operator creates and returns a small intermediary object that references the customers collection and provides a filtered view of that collection. Because there is very little cost associated with creating and initializing the intermediary object, execution of the statement above is very fast. The real work of the query does not occur until the sequence is enumerated (for example in a foreach statement), and the work is then amortized over the entire enumeration.

With deferred execution it is not necessary to materialize a query in a separate collection. For example, given a PrintOrders method:

```
void PrintOrders(sequence<Order> orders) {
      foreach (Order o in orders) {
      ...
      }
}
```

it is possible to pass a query itself (rather than the results of a query) to the method:

PrintOrders(customers.where(State == “CA”).
select(Orders).where(OrderDate.Year == 2003));

The sequence passed to PrintOrders is just a small object that aliases the customers collection and applies the appropriate filters and transformations. The results of the query are never materialized in a separate collection, rather they are computed “on the fly” as the sequence is enumerated in the PrintOrders method. Thus, deferred execution is demand-driven.

Deferred execution provides benefits when sequence objects are composed. For example, consider the following rewritten version of the code above:

sequence<Customer> custs = customers.where(State == “CA”);
sequence<Orders> orders = custs.select(Orders);
PrintOrders(orders.where(OrderDate.Year == 2003));

Because the custs and orders temporary sequences are not materialized, there is little or no cost associated with breaking the large query into multiple smaller queries.

With respect to a sequence and a database cursor, a database cursor represents the result of a query, and a sequence represents the query itself. A sequence can be enumerated multiple times and each enumeration re-executes the query.

sequence<Customer> locals = customers.where(ZipCode == 98112);
foreach (Customer c in locals) Foo(c);
foreach (Customer c in locals) Bar(c);

In the code above, if customers were added or removed from the customers collection between the two foreach statements, the second foreach statement will reflect the changes.

Materialization of a sequence can be forced by copying the sequence into a collection. For example, the List<T> collection class has a constructor that enumerates a sequence<T> and adds its elements to the newly created list:

sequence<Customer> list =
new List<Customer>(customers.where(ZipCode == 98112));

The code above illustrates a nice way in which sequence operators combine with the existing language. At the cost of one small object (the object created by the where operator) it is possible to pass a query as an argument to the List<T> constructor.

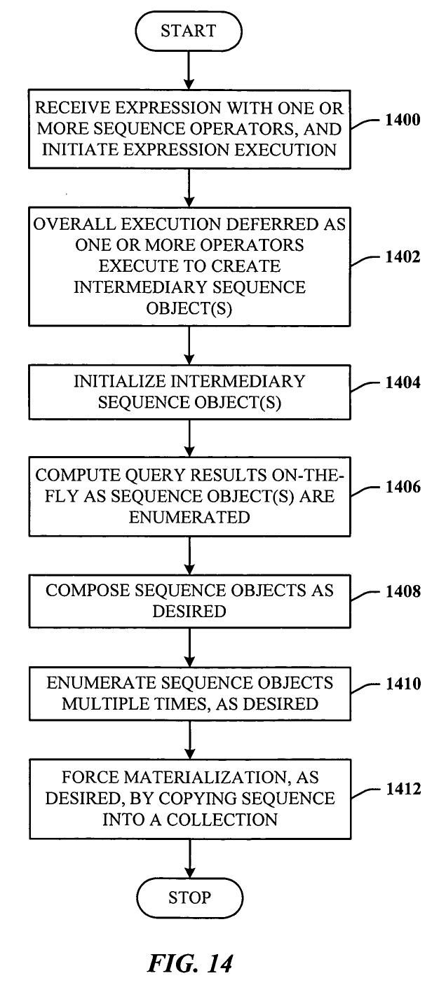

Accordingly, FIG. 14 illustrates a methodology providing deferred execution in accordance with an innovative aspect. At 1400, an expression with one or more sequence operators is received, and expression execution is initiated. At 1402, overall execution is deferred as one or more operators execute to create one or more intermediary sequence objects. At 1404, the one or more intermediary objects are initialized. At 1406, query results are computed on-the-fly as sequence objects are enumerated. At 1408, sequence objects can be composed, as desired. At 1410, sequence objects can be enumerated multiple time, as desired. At 1412, materialization can be forced, as desired, by copying a sequence into a collection.

An implementation strategy for sequence operators described supra works well for in-memory data structures. However, when a sequence<T> represents a remote collection, such as a database table, remote query execution is supported. For example, consider a simple O-R mapping that provides a strongly-typed view of a database by representing each table as an appropriate instantiation of a generic Table<T> class:

```
public class Table<T>: IEnumerable<T>
{
    ...
}
public class Northwind: Database
{
    public Table<Customer> Customers { get; }
    public Table<Order> Orders { get; }
    public Table<LineItem> LineItems { get; }
    public Table<Product> Products { get; }
    ...
}
```

The following would be a typical usage scenario:

Northwind db = new Northwind( );
foreach (Customer c in db.Customers.where(State == “CA”)) {
ProcessCustomer(c);
}

A problem here can be that the query expressed by the where operator would execute locally. The enumerator of the Customers table loads every customer from the database, and the local code then immediately throws away those customers that do not satisfy the predicate. In contrast, it is advantageous to remote the query to the database and bring back only the relevant customers.

To permit the remoting of queries, an IQueryable<T> interface or some other class or interface type that serves the purpose of representing remote data sources is disclosed:

public interface IQueryable<T>: IEnumerable<T>
{
IQueryable<U> Query<U>(QueryExpr query);
}

IQueryable<T> inherits from IEnumerable<T> and adds the ability to execute a query given by an expression tree. Along with IQueryable<T> is a set of concrete classes for building such expression trees (as subclasses of the abstract base class Q

ueryExpr used in the Query method).

Similar to the sequence<T> shorthand for IEnumerable<T>, the syntax query<T> is permitted as an alias for IQueryable<T>.

The Table<T> class in the O-R mapping example above implements IQueryable<T>. When the source sequence of a sequence operator implements IQueryable<T>, the compiler generates a query expression tree instead of generating a helper class. For example, the query

query<Customer>q=db.Customers.where(State==“CA”); is translated into something like,

```
query<Customer> q = db.Customers.Query<Customer>(
    new QueryWhere(
        new QueryEquals(
            new QueryProperty(“State”),
            new QueryConstant(“CA”))));
```

The actual strategy for executing the query is up to Table<T>'s implementation of the Query method in the IQueryable<T> interface. Presumably, the Query method will return an object that holds on to the query tree. When an enumerator is later requested from this object, the query is translated into SQL and sent to the database, and the result set is made available through the enumerator.

Certain restrictions can apply to predicate and projection expressions when the source sequence is a query<T>. For example, an expression specified with the where operator should not be permitted to call arbitrary methods, since the presence of those methods is not guaranteed in the remote environment.

Deferred execution means that it is possible to compose query trees. Consider the following method that takes a queryable sequence of customers as a parameter:

```
    void ProcessCustomers(query<Customer> custs) {
        query<Customer> custsWithOrders =
custs.where(exists(Orders));
        foreach (Customer c in custsWithOrders) {
            ...
        }
    }
```

The following two invocations effectively pass encapsulated query trees to the method:

ProcessCustomers(db.Customers.where(ZipCode == 98112));
ProcessCustomers(db.Customers.where(State == “CA”));

When the custs parameter is further queried in the method, it is possible for the underlying IQueryable<T> implementation to just merge the query trees. Then, once an enumerator is requested in the foreach statement, a query combining the two predicates can be sent to the database. IQueryable is a piece of code that when executed, returns an object, that when requested, will return the object.

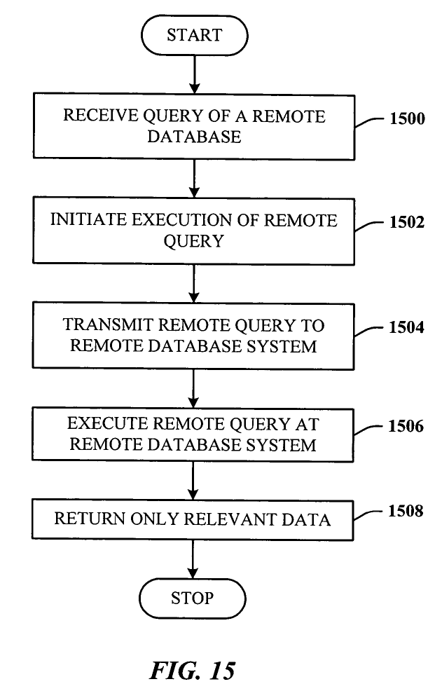

Accordingly, FIG. 15 illustrates a methodology of remoting a query to a remote database in accordance with an aspect. At 1500, a query is received for a remote database or data source. At 1502, execution of remote query is initiated. At 1504, the query is transmitted to the remote database system (or data source). At 1506, the remote query is executed at the data source. At 1508, only relevant data results are returned.

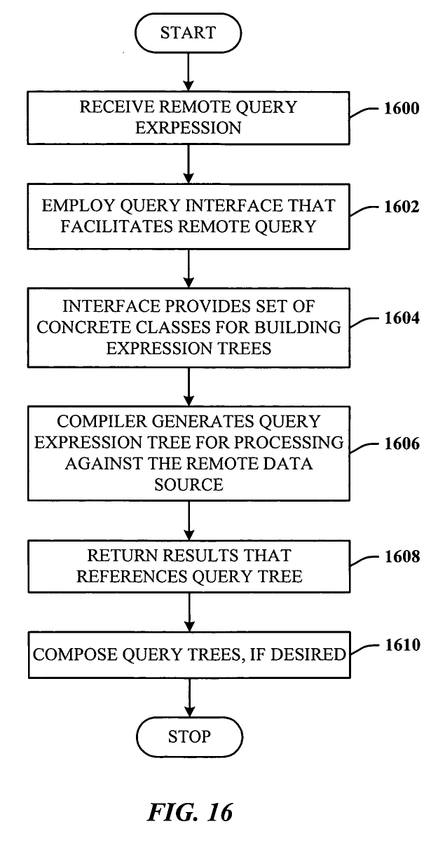

FIG. 16 illustrates a flow diagram of a methodology compiler processing in response to remoting a query according to an aspect. At 1600, a remote query expression is received. At 1602, a query interface (e.g., IQueryable<T>) is employed that facilitates remote query processing. At 1604, the query interface provides a set of concrete classes for building expression trees. At 1606, the compiler generates a query expression tree that is utilized at the remote database to return a set of results. At 1608, the results are returned that references the query tree. At 1610, query trees can be composed, if desired.

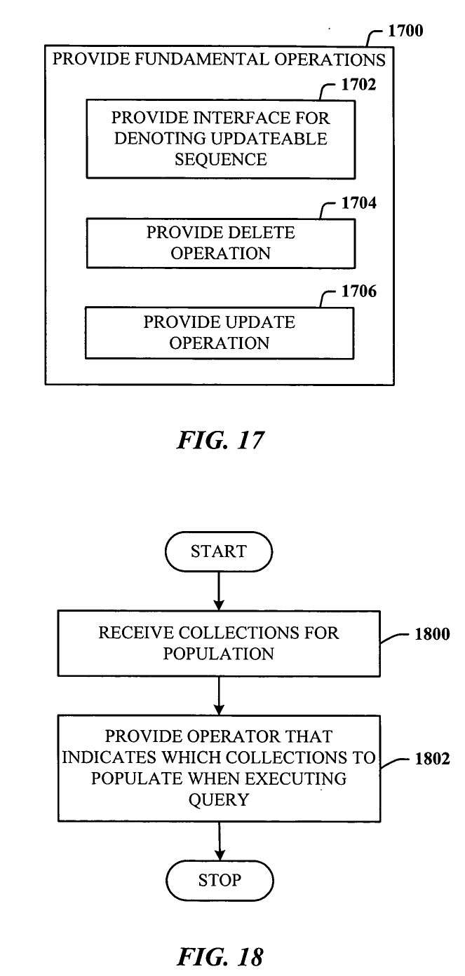

FIG. 17 illustrates a block diagram representative of an operator 1700 that provides fundamental operations in accordance with an aspect. Databases typically provide four fundamental operations: Create, Read, Update, and Delete. Sequence operators are primarily concerned with querying (e.g., Read operations), but some language support for the other operations, in particular Update and Delete can be provided.

Few, if any, language extensions are required for O-R mappings to provide adequate support for Create operations. Referring to the Table<T> class above, one can consider a class supporting an Add(T) method that adds new rows to the underlying database table. Update and Delete operations, on the other hand, require some way of expressing which rows that are to be updated and deleted, and sequence operator queries are a natural choice for this.

Accordingly, the operator 1700 provides an interface 1702 for denoting an updateable sequence. An IUpdateable<T> interface, derived from IQueryable<T>, is provided to represent a sequence that is updateable:

```
public interface IUpdateable<T>: IQueryable<T>
{
    void Delete( );
    void Update(UpdateExprList updates);
}
```

At 1704, a delete statement takes an IUpdateable<T> sequence as an argument. For example, the following code deletes those customers that have no orders:
delete(db.Customers.where(!exists(Orders)));

At 1706, an update statement is provided applies a list of assignment statements to an IUpdateable<T> sequence. For example, the following raises the price of all products in the “Wine” category by 10 percent:
update(db.Products.where(Category==“Wine”)){UnitPrice*=1.1;};

Because of deferred execution, sequences passed to delete and update are never actually materialized. Rather, the sequences are represented as expression trees, which is precisely the desired representation for an underlying O-R mapping. The assignment(s) specified in an update statement would likewise be represented as expression trees.

Only where operators can be permitted on updateable sequences. When a where operator is applied to an IUpdateable<T> interface, the resulting sequence is still an IUpdateable<T>. For some other combinations of sequence operators, the resulting sequence may not be updateable, and thus, will demote to IQueryable<T>.

FIG. 18 illustrates a flow diagram of a methodology of populating a collection when executing a query. Accordingly, at 1800, collections are received for populating. At 1802, an operator is provided that indicates which collections to populate when executing a query. Introduced, is the notion of a “span” which indicates which sub-collections to eagerly populate when executing a query. A span is specified as a string and is not subject to compile-time checking. A span is specified as an including operator and it is compiler-time checked:

db.Customers.where(State ==
“CA”).including(Orders.including(LineItems))

The including operator in the query above indicates that each customer's Orders collection and each order's LineItems collection should be fetched from the database at the same time as the customers themselves.

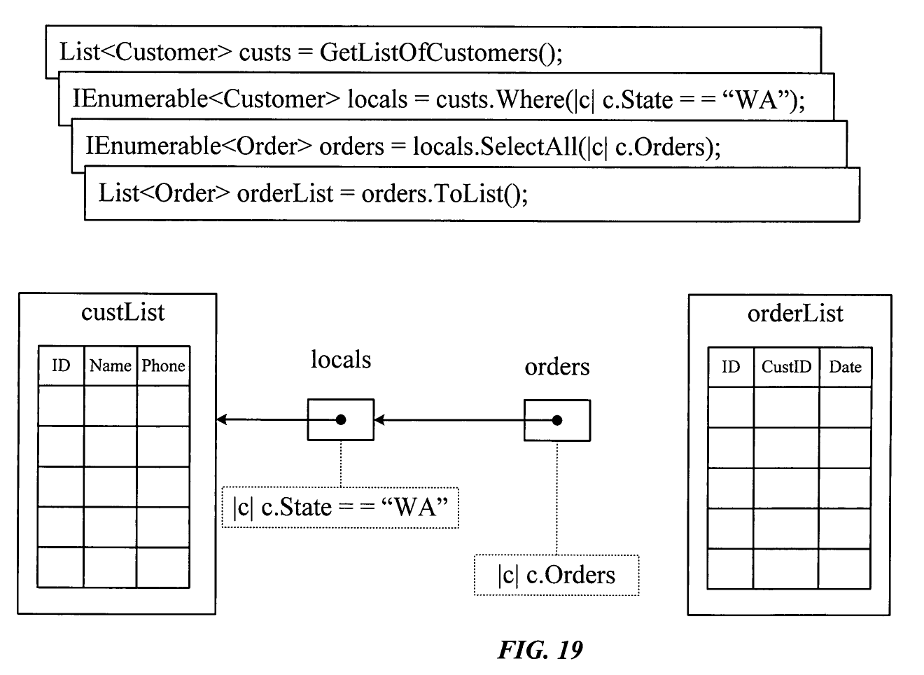

FIG. 19 illustrates exemplary code to depict deferred query execution. The locals and orders are intermediary objects that are processed before the overall expression is processed.

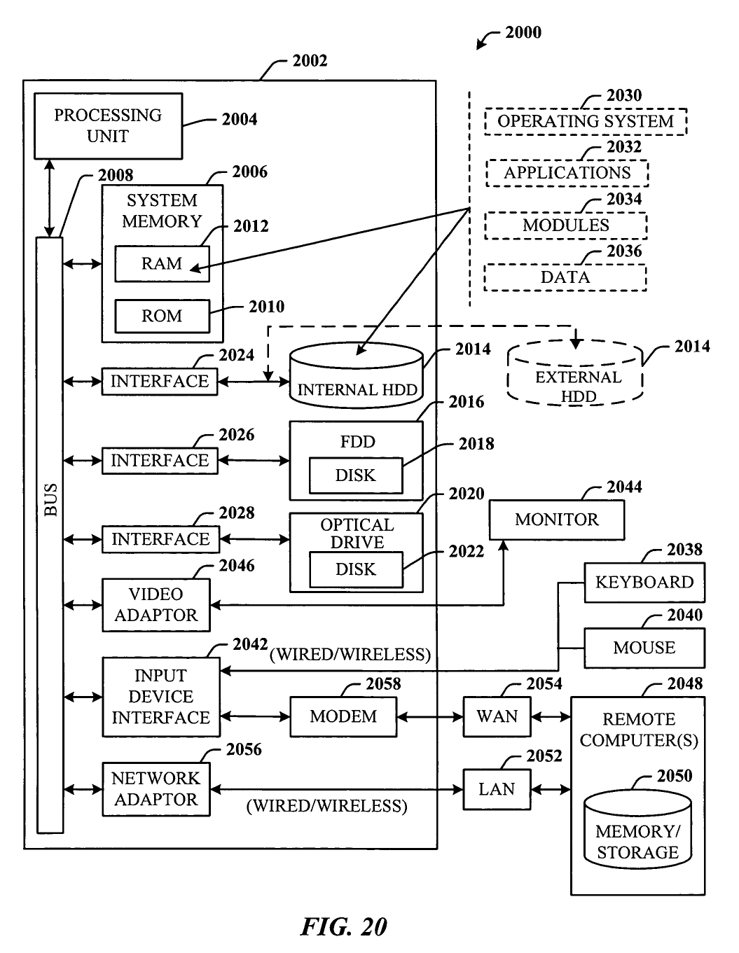

Referring now to FIG. 20, there is illustrated a block diagram of a computer operable to execute the disclosed programming language architecture. In order to provide additional context for various aspects thereof, FIG. 20 and the following discussion are intended to provide a brief, general description of a suitable computing environment 2000 in which the various aspects of the innovation can be implemented. While the description above is in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and non-volatile media, removable and non-removable media. By way of example, and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 20, the exemplary environment 2000 for implementing various aspects includes a computer 2002, the computer 2002 including a processing unit 2004, a system memory 2006 and a system bus 2008. The system bus 2008 couples system components including, but not limited to, the system memory 2006 to the processing unit 2004. The processing unit 2004 can be any of various commercially available processors. Dual microprocessors and other multi-processor architectures may also be employed as the processing unit 2004.

The system bus 2008 can be any of several types of bus structure that may further interconnect to a memory bus (with or without a memory controller), a peripheral bus, and a local bus using any of a variety of commercially available bus architectures. The system memory 2006 includes read-only memory (ROM) 2010 and random access memory (RAM) 2012. A basic input/output system (BIOS) is stored in a non-volatile memory 2010 such as ROM, EPROM, EEPROM, which BIOS contains the basic routines that help to transfer information between elements within the computer 2002, such as during start-up. The RAM 2012 can also include a high-speed RAM such as static RAM for caching data.

The computer 2002 further includes an internal hard disk drive (HDD) 2014 (e.g., EIDE, SATA), which internal hard disk drive 2014 may also be configured for external use in a suitable chassis (not shown), a magnetic floppy disk drive (FDD) 2016, (e.g., to read from or write to a removable diskette 2018) and an optical disk drive 2020, (e.g., reading a CD-ROM disk 2022 or, to read from or write to other high capacity optical media such as the DVD). The hard disk drive 2014, magnetic disk drive 2016 and optical disk drive 2020 can be connected to the system bus 2008 by a hard disk drive interface 2024, a magnetic disk drive interface 2026 and an optical drive interface 2028, respectively. The interface 2024 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 2002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the disclosed innovation.

A number of program modules can be stored in the drives and RAM 2012, including an operating system 2030, one or more application programs 2032, other program modules 2034 and program data 2036. All or portions of the operating system, applications, modules, and/or data can also be cached in the RAM 2012. It is to be appreciated that the innovation can be implemented with various commercially available operating systems or combinations of operating systems.

A user can enter commands and information into the computer 2002 through one or more wired/wireless input devices, e.g., a keyboard 2038 and a pointing device, such as a mouse 2040. Other input devices (not shown) may include a microphone, an IR remote control, a joystick, a game pad, a stylus pen, touch screen, or the like. These and other input devices are often connected to the processing unit 2004 through an input device interface 2042 that is coupled to the system bus 2008, but can be connected by other interfaces, such as a parallel port, an IEEE 1394 serial port, a game port, a USB port, an IR interface, etc.

A monitor 2044 or other type of display device is also connected to the system bus 2008 via an interface, such as a video adapter 2046. In addition to the monitor 2044, a computer typically includes other peripheral output devices (not shown), such as speakers, printers, etc.

The computer 2002 may operate in a networked environment using logical connections via wired and/or wireless communications to one or more remote computers, such as a remote computer(s) 2048. The remote computer(s) 2048 can be a workstation, a server computer, a router, a personal computer, portable computer, microprocessor-based entertainment appliance, a peer device or other common network node, and typically includes many or all of the elements described relative to the computer 2002, although, for purposes of brevity, only a memory/storage device 2050 is illustrated. The logical connections depicted include wired/wireless connectivity to a local area network (LAN) 2052 and/or larger networks, e.g., a wide area network (WAN) 2054. Such LAN and WAN networking environments are commonplace in offices and companies, and facilitate enterprise-wide computer networks, such as intranets, all of which may connect to a global communications network, e.g., the Internet.

When used in a LAN networking environment, the computer 2002 is connected to the local network 2052 through a wired and/or wireless communication network interface or adapter 2056. The adaptor 2056 may facilitate wired or wireless communication to the LAN 2052, which may also include a wireless access point disposed thereon for communicating with the wireless adaptor 2056.

When used in a WAN networking environment, the computer 2002 can include a modem 2058, or is connected to a communications server on the WAN 2054, or has other means for establishing communications over the WAN 2054, such as by way of the Internet. The modem 2058, which can be internal or external and a wired or wireless device, is connected to the system bus 2008 via the serial port interface 2042. In a networked environment, program modules depicted relative to the computer 2002, or portions thereof, can be stored in the remote memory/storage device 2050. It will be appreciated that the network connections shown are exemplary and other means of establishing a communications link between the computers can be used.

The computer 2002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11 a) or 54 Mbps (802.1 lb) data rate, for example, or with products that contain both bands (dual band), so the networks can provide real-world performance similar to the basic 10BaseT wired Ethernet networks used in many offices.

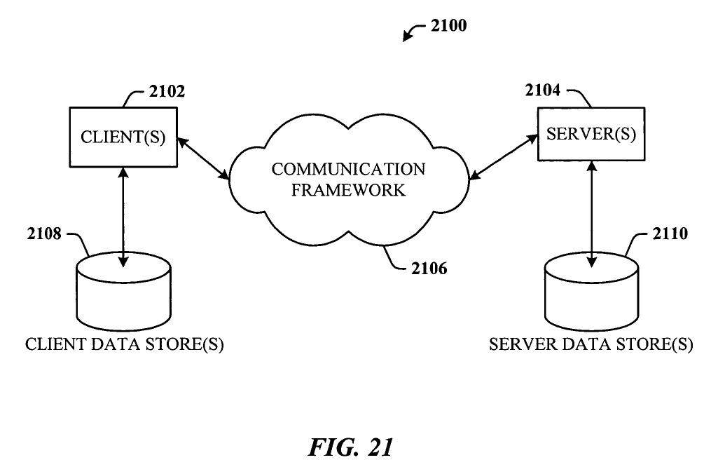

Referring now to FIG. 21, there is illustrated a schematic block diagram of an exemplary computing environment 2100 that facilitates execution of embedded operators of a programming language in accordance with another aspect. The system 2100 includes one or more client(s) 2102. The client(s) 2102 can be hardware and/or software (e.g., threads, processes, computing devices). The client(s) 2102 can house cookie(s) and/or associated contextual information by employing the subject innovation, for example.

The system 2100 also includes one or more server(s) 2104. The server(s) 2104 can also be hardware and/or software (e.g., threads, processes, computing devices). The servers 2104 can house threads to perform transformations by employing the invention, for example. One possible communication between a client 2102 and a server 2104 can be in the form of a data packet adapted to be transmitted between two or more computer processes. The data packet may include a cookie and/or associated contextual information, for example. The system 2100 includes a communication framework 2106 (e.g., a global communication network such as the Internet) that can be employed to facilitate communications between the client(s) 2102 and the server(s) 2104.

Communications can be facilitated via a wired (including optical fiber) and/or wireless technology. The client(s) 2102 are operatively connected to one or more client data store(s) 2108 that can be employed to store information local to the client(s) 2102 (e.g., cookie(s) and/or associated contextual information). Similarly, the server(s) 2104 are operatively connected to one or more server data store(s) 2110 that can be employed to store information local to the servers 2104.

What has been described above includes examples of the disclosed innovation. It is, of course, not possible to describe every conceivable combination of components and/or methodologies, but one of ordinary skill in the art may recognize that many further combinations and permutations are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates querying data, comprising:
a program component that provides embedded query and set operations in a programming language; and
an application component that facilitates application of the query and set operations over a data structure.

2. The system of claim 1, wherein the data structure is an in-memory collection.

3. The system of claim 1, wherein the data structure is a remote collection.

4. The system of claim 1, wherein the application component represents a sequence of objects of a specified type.

5. The system of claim 1, wherein the data structure implements an interface or type that provides a forward-only enumeration of a collection.

6. The system of claim 1, wherein the application component includes an interface that is at least one of: strongly typed; representative of an array, a collection, a database table, and a database query; allows multiple enumerations of a represented sequence; allows deferred execution of work related to producing the represented sequence; represents a database query; and, is operable under composition.

7. The system of claim 1, wherein the set of operations include at least one of restriction, projection, testing, aggregation, ordering, grouping, sets, catenation, casting, singleton, conversion, and partition.

8. The system of claim 1, wherein the data structure is an interface or type that facilitates remoting a query or a set operation to a remote data source.

9. The system of claim 1, wherein the application component utilizes an expression tree that facilitates remoting a query or a set operation to a remote data source.

10. The system of claim 1, wherein embedded query and set operations are checked at compile-time.

11. The system of claim 1, wherein the application component facilitates composition of operations utilizing deferred execution such that no intermediate data structure is created until a final result of the composition of operations is required.

12. A computer-readable medium having stored thereon computer-executable instructions for carrying out the system of claim 1.

13. A computer that employs the system of claim 1.

14. A computer-implemented method of accessing data, comprising:
embedding query and set operations in a programming language in part as operators;
providing a generic interface that represents a sequence of objects of a specified type; and
checking one or more of the query and set operations at compile time.

15. The method of claim 14, further comprising an act of deferring execution by generating an intermediary object which is a sequence object of the sequence.

16. The method of claim 14, further comprising an act of remoting a query to a data source for execution.

17. The method of claim 14, further comprising an act of explicitly naming a current element of the sequence to allow multiple elements to be in scope substantially simultaneously.

18. The method of claim 14, further comprising an act of providing database operations associated with at least one of create, update and delete.

19. The method of claim 14, further comprising an act of requesting a collection according to demand.

20. A system that facilitates data access, comprising:
means for embedding query and set operations in a programming language in part as operators;
means for remoting a query to a data source;
means for representing a sequence of objects of a specified type; and
means for checking one or more of the query and set operations at compile time.
